(19) United States
(12) Patent Application Publication
(10) Pub. No.: US 2026/0119095 A1
(43) Pub. Date: Apr. 30, 2026

(54) COMMUNICATION DEVICE, CONTROL METHOD, AND STORAGE MEDIUM STORING PROGRAM

(71) Applicant: CANON KABUSHIKI KAISHA, Tokyo (JP)

(72) Inventor: Tokiko Watanabe, Tokyo (JP)

(21) Appl. No.: 19/361,299

(22) Filed: Oct. 17, 2025

(30) Foreign Application Priority Data
Oct. 24, 2024 (JP) 2024-187682

(51) Int. Cl. G06F 3/12

(52) U.S. Cl. CPC G06F 3/1239; G06F 3/1203; G06F 3/1286

(57) ABSTRACT

A communication device includes: a connection setting unit that executes connection setting processing for connecting the communication device to an external access point; a setting unit that performs setting so as to restrict a function of the communication device; and a first control unit that performs control so as to, in a case where a function necessary for executing the connection setting processing is restricted by the setting unit, not start the connection setting processing and display information indicating that the function is restricted.

### BACKGROUND

### Field of the Technology

The present disclosure relates to a communication device capable of executing connection setting processing, a control method, and a storage medium storing a program.

### Description of the Related Art

Image processing devices such as printers, which communicate with terminal devices such as personal computers (PCs) and smartphones, are known. Such image processing devices, for example, execute connection setting processing to communicate with terminal devices by predetermined communication methods such as Wi-Fi®. Regarding connection setting processing, there is a technology that minimizes wireless LAN connection setting operations on the image processing device side by executing connection setting using a tool (application) on the terminal device (Japanese Patent Laid-Open No. 2015-23441).

Meanwhile, personal computers (PCs) and server devices (e.g., file servers and authentication servers) that connect to networks such as those in offices are preferably operated in accordance with security policies defined for each office. Here, complying with the security policy refers to establishing restrictions on security-related operations of the image processing device to prevent unauthorized use and information leakage, such as requiring user authentication when operating the image processing device and requiring encryption of communication paths, for example. In such image processing devices, control is performed to maintain a state that complies with the security policy. Specifically, when a certain security policy is set, specific setting items related to that security policy become fixed values and can no longer be changed by users other than security administrators (Japanese Patent Laid-Open No. 2017-163557).

### SUMMARY

The present disclosure provides a communication device capable of notifying that connection setting processing cannot be completed due to a setting when the connection setting processing cannot be completed due to that setting, a control method, and a storage medium storing a program.

The present disclosure in one aspect provides a communication device comprising: at least one memory and at least one processor which function as: a connection setting unit configured to execute connection setting processing for connecting the communication device to an external access point; a setting unit configured to perform setting so as to restrict a function of the communication device; and a first control unit configured to perform control so as to, in a case where a function necessary for executing the connection setting processing is restricted by the setting unit, not start the connection setting processing and display information indicating that the function is restricted.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration of a system.

FIGS. 2A and 2B are diagrams illustrating configurations of an MFP.

FIGS. 3A to 3C are diagrams illustrating an operation display unit of the MFP.

FIG. 4A and FIG. 4B are diagrams illustrating configurations of a mobile terminal device.

FIG. 5 is a diagram illustrating a configuration of an access point.

FIG. 6 is a diagram illustrating a software configuration of the MFP.

FIGS. 7A and 7B are flowcharts for explaining processing executed in the MFP.

FIG. 8 is a flowchart for explaining processing executed in the MFP.

FIGS. 9A and 9B are diagrams illustrating a user interface screen.

FIG. 10 is a sequence diagram of processing executed between devices.

FIG. 11 is a flowchart for explaining processing executed in the MFP.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

In a communication device, when performing connection setting processing for a wireless LAN connection, if the communication for that connection setting processing is set to be restricted, a user cannot recognize that they cannot complete the connection setting processing due to that setting.

According to the present disclosure, when connection setting processing cannot be completed due to a setting, it is possible to notify that the connection setting processing cannot be completed due to that setting.

### (Configuration of System)

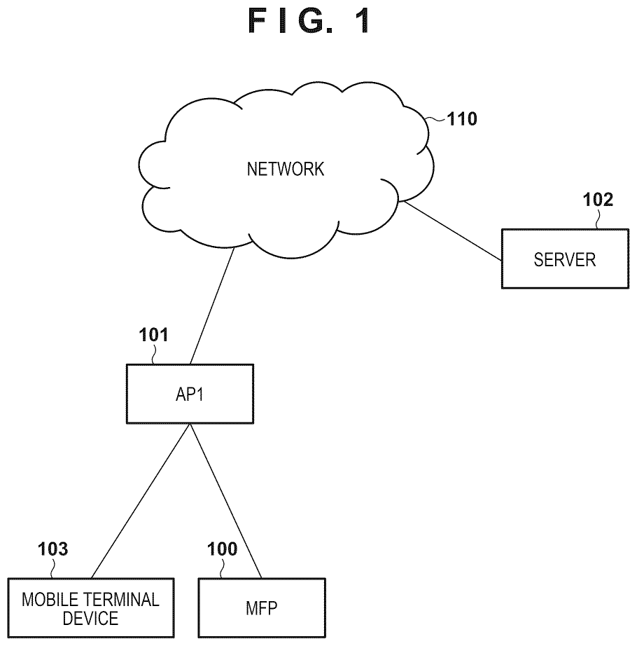

FIG. 1 illustrates an example of a configuration of a system according to the present embodiment. In one example, the system is a wireless communication system in which a plurality of communication devices can wirelessly communicate with each other. The example of FIG. 1 includes a mobile terminal device 103 and an MFP 100 as communication devices, an AP 101 which is an access point, a server 102, and a network 110. The AP 101 may be illustrated as AP1. The AP 101 is, specifically, a wireless LAN router, for example. The mobile terminal device 103 is a device having a function for wireless communication by a wireless LAN or the like. In the following, a wireless LAN may be referred to as a WLAN. The mobile terminal device 103 may be a personal information terminal (e.g., a personal digital assistant (PDA)), a mobile telephone (smartphone), a digital camera, a personal computer, or the like. In the present embodiment, the connection between the mobile terminal device 103 and the AP 101, as well as the connection between the MFP 100 and the AP 101, are assumed to be connections using a communication method based on the IEEE 802.11 series standards. A communication method based on the IEEE 802.11 series standards is, specifically, Wireless Fidelity (Wi-Fi)®.

The MFP 100 is a printing device or an image forming device having a printing function and may further include a reading function (scanner), a FAX function, and a telephone function. Further, the MFP 100 of the present embodiment has a communication function that allows wireless communication with the mobile terminal device 103. Further, in the present embodiment, a case where the MFP 100 is used will be described as an example, but the present invention is not limited thereto. For example, a scanner device, a projector, a mobile terminal, a smartphone, a notebook PC, a tablet terminal, a PDA, a digital camera, a music player, a TV, a smart speaker, or the like, each having a communication function, may be used in place of the MFP 100. MFP is an acronym of Multi Function Peripheral.

The AP 101 is provided separately from (external to) the mobile terminal device 103 and the MFP 100 and operates as a WLAN base station device. A communication device having a WLAN communication function can communicate in WLAN infrastructure mode via the AP 101. In the following, an access point may be referred to as an “AP”. The infrastructure mode may be referred to as the “infrastructure connection mode”. The AP 101 performs wireless communication with an (authenticated) communication device with which it has permitted to connect, and relays wireless communication between that communication device and another communication device. The AP 101 may, for example, be connected to a wired communication network and relay communication between a communication device connected to the wired communication network and another communication device wirelessly connected to the AP 101.

The server 102 is connected to the MFP 100 via the AP 101 and the network 110, and provides services to the MFP 100 by responding to requests from the MFP 100. Here, the network 110 may be the so-called Internet or may be a closed network in a company or a mobile phone network. The system according to the present embodiment is not limited to the configuration illustrated in FIG. 1 and may include, for example, an authentication server that performs the above authentication.

### (External Configuration of MFP)

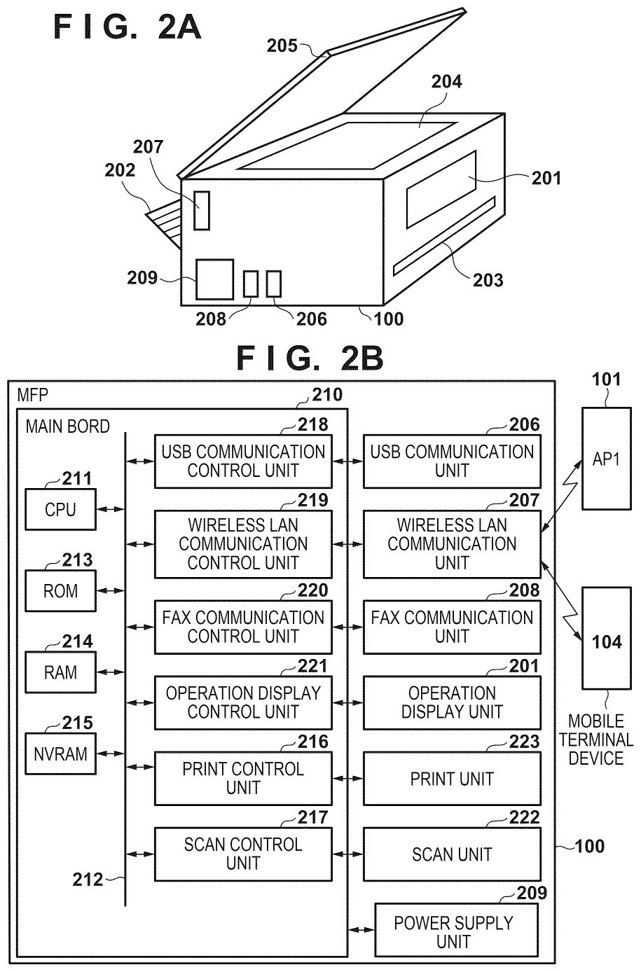

FIG. 2A illustrates an example of an external configuration of the MFP 100. The MFP 100 includes, for example, an operation display unit 201, a printing sheet insertion port 202, a printing sheet discharge port 203, a document table 204, and a document cover 205.

The operation display unit 201 is configured to include keys (e.g., character input keys, a cursor key, an enter key, and a cancel key), an LED or LCD, and the like, and is configured to be capable of accepting activation of various functions and operations for various settings for the MFP by a user. The operation display unit 201 may be configured to include a touch panel display. The printing sheet insertion port 202 is an insertion port in which sheets of various sizes can be set. The printing sheet discharge port 203 is a discharge port for discharging a sheet on which printing has been completed. Sheets set in the printing sheet insertion port 202 are conveyed to a printing unit one at a time and, after printing has been performed thereon in the printing unit, are discharged from the printing sheet discharge port 203. The document table 204 is a table on which a document to be read is placed. The document cover 205 is a cover for holding a document placed on the document table 204 and for preventing light from a light source that irradiates the document from leaking out at the time of reading.

The MFP 100 has a USB communication function, and a USB communication unit 206 is configured to include a USB connector and a circuit for communication via USB connection. The MFP 100 has a function for wireless communication by a WLAN, and a communication unit 207 for wireless communication therefor is configured to include an antenna for wireless communication although it need not necessarily be externally visible. Similarly to the mobile terminal device 103, the MFP 100 can perform wireless communication in 2.4-GHz and 5-GHz frequency bands by a WLAN. The MFP 100 has a FAX communication function, and a FAX communication unit 208 includes a telephone line connector and a circuit for FAX transmission and reception. A power supply unit 209 includes a power supply jack and a power supply circuit for supplying power to the MFP 100.

### (Configuration of MFP)

FIG. 2B illustrates an example of a configuration of the MFP 100. The MFP 100 is configured to include a main board 210 which performs overall control of the device itself, the operation display unit 201, the USB communication unit 206, the wireless LAN communication unit 207, the FAX communication unit 208, the power supply unit 209, a print unit 223, and a scan unit 222.

A CPU 211 in the form of a microprocessor arranged on the main board 210 operates according to a control program stored in a ROM 213 connected via an internal bus 212 and data stored in a RAM 214. The processes of the MFP 100 to be described below are realized, in one example, by the CPU 211 executing a program stored in the ROM 213. Dedicated hardware for each process may be provided. The ROM 213 is an example of a computer-readable storage medium storing control programs, an embedded OS program, and the like to be executed by the CPU 211. An OS is an operating system. In the present embodiment, the CPU 211 performs software control, such as scheduling and task switching, by executing the respective control programs stored in the ROM 213 under the management of the embedded OS, which is similarly stored in the ROM 213.

The RAM 214 is constituted by an SRAM or the like. The RAM 214 stores data such as program control variables and data such as setting values registered by the user and management data of the MFP 100. The RAM 214 may be used as a buffer for various kinds of work. A non-volatile memory 215 is constituted by a memory, such as a flash memory, for example, and continues to store data even when the power of the MFP 100 is turned off. The RAM 214 and the non-volatile memory 215 are used as image memories, for example, and store image data received through the wireless LAN communication unit 207, image data subjected to encoding/decoding processing, and the like.

The CPU 211 reads a document by controlling the scan unit 222 via a scan control unit 217, and stores it in an image memory that is part of the RAM 214, for example. Further, the CPU 211 can print image data held, for example in the image memory that is part of the RAM 214, onto a printing medium such as printing paper by controlling the print unit 223 via a print control unit 216. The scan unit 222 optically reads a document placed on the document table 204, for example, using a contact image sensor (CIS). The scan control unit 217 converts an image obtained by optically reading the document into electrical image data (image signal) and outputs it. At this time, the scan control unit 217 may output the image data after performing various kinds of image processing such as binarization processing and halftone processing. The print control unit 216 performs various kinds of image processing, such as smoothing processing, printing density correction processing, and color correction, on image data to be printed and outputs the processed image data to the print unit 223. The print unit 223 is configured to be capable of executing, for example, inkjet print processing, and prints an image on a printing medium, such as a printing sheet, by causing a print head to discharge ink supplied from an ink tank. The print unit 223 may be configured to be capable of executing another kind of print processing such as electrophotographic print processing. The print control unit 216 may periodically read out information of the print unit 223 and update, for example, status information including the remaining amount of ink in the ink tank, the status of the print head, and the like stored in the RAM 214.

The CPU 211 performs USB communication via USB connection with an external device by controlling the USB communication unit 206 via a USB communication control unit 218. Further, the CPU 211 performs wireless LAN communication via infrastructure connection or direct connection with an external device by controlling the wireless LAN communication unit 207, which is one communication module that performs WLAN communication using at least one shared antenna, via a wireless LAN communication control unit 219.

The wireless LAN communication unit 207 is a unit capable of providing a WLAN communication function and can provide a function similar to a WLAN unit 429 of the mobile terminal device 103, for example. That is, the wireless LAN communication unit 207 converts data into packets and transmits the packets to another device according to a WLAN standard, and reconstructs original data from packets from another, external device and outputs it to the CPU 211. The wireless LAN communication unit 207 is capable of communicating as a station conforming to the IEEE 802.11 standard series, in particular, communication conforming to IEEE 802.11a/b/g/n/ac/ax.

The mobile terminal device 103 and the MFP 100 are capable of direct communication that is based on Wi-Fi Direct (WFD), and the wireless LAN communication unit 207 has a software access point (soft AP) function or a group owner function. That is, the wireless LAN communication unit 207 can construct a direct communication network and determine the channel to be used in direct communication.

The CPU 211 performs FAX communication that uses a telephone line with an external device by controlling the FAX communication unit 208 via a FAX communication control unit 220. The CPU 211 can accept operation information from the operation display unit 201 via an operation display control unit 221. Further, the CPU 211 executes display on a display, generation of signals in response to acceptance of user operations, and the like by controlling the operation display unit 201 via the operation display control unit 221. The operation display unit 201 corresponds to the operation display unit 201 of FIG. 2A.

### (Operation Display Unit of MFP)

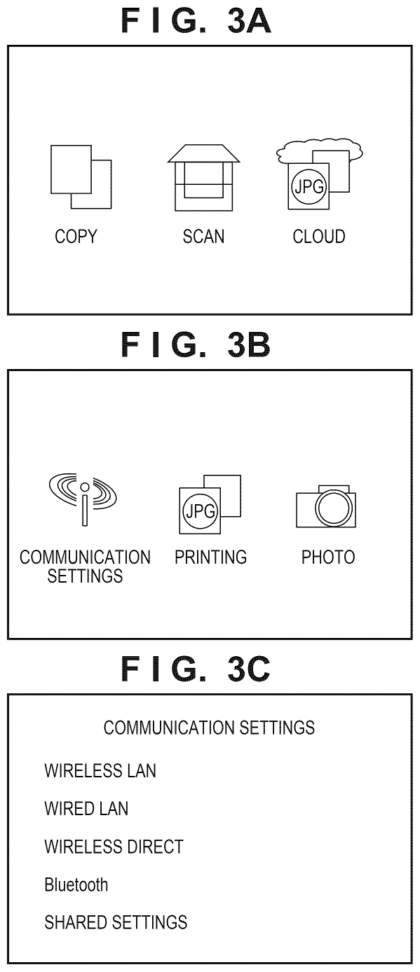

FIGS. 3A to 3C schematically illustrate examples of screen displays in a display (touch panel display) included in the operation display unit 201 of the MFP 100. FIG. 3A is an example of a home screen to be displayed when the power of the MFP 100 is turned on and while no operation, such as printing or scanning, is being performed (idle state and standby state). In FIG. 3A, display items (menu items), respectively corresponding to copy, scan, and cloud, are displayed. Cloud is a menu item related to a cloud function that uses Internet communication. The MFP 100 may start execution of a corresponding setting or function by one of the menu items being selected by a key operation or a touch panel operation. The MFP 100 can display a screen that is different from FIG. 3A in a seamless manner by accepting a key operation or a touch panel operation on the home screen in FIG. 3A.

FIG. 3B is an example of display of another part of the home screen and is a screen to which transition is made from the state of FIG. 3A by an operation (e.g., a left/right sliding operation) for displaying another page of the home screen. In FIG. 3B, display items (menu items), respectively corresponding to communication settings, print, and photo, are displayed. When one of these menu items is selected, the function, that is, a print function, a photo function, or communication settings, corresponding to the selected menu item is executed.

FIG. 3C is an example of a display of a communication setting menu screen to be displayed when communication settings is selected on the screen of FIG. 3B. “Wireless LAN”, “wired LAN”, “Wireless Direct”, “Bluetooth” and “shared settings” are displayed as menu items (options) on the communication setting menu screen. “Wireless LAN”, “wired LAN”, and “Wireless Direct” are menu items for performing LAN settings, and from these items, settings such as wired connection settings, an infrastructure connection mode enable/disable setting, and a direct connection mode (e.g., WFD and soft AP mode) enable/disable setting can be performed. If the item “wireless LAN” is selected and a wireless LAN is set to enabled by a user operation, infrastructure connection mode will be enabled. If the item “Wireless Direct” is selected and Wireless Direct is set to enabled by a user operation, direct connection mode will be enabled. In addition, by the item “shared settings” being selected, a shared setting menu related to each form of connection is displayed, and the user can perform, for example, wireless LAN frequency band and frequency channel settings.

### (External Configuration of Mobile Terminal Device)

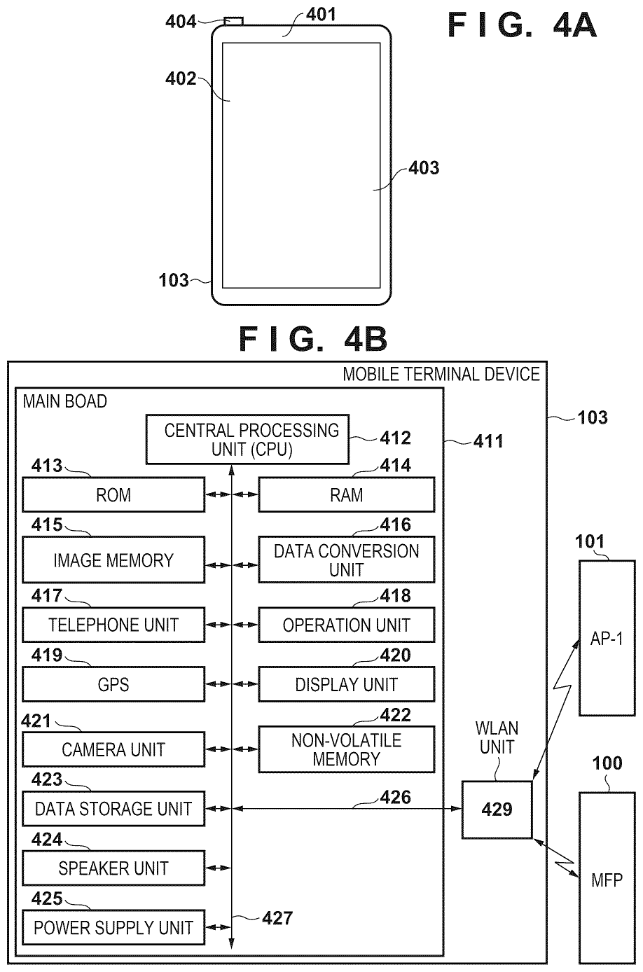

FIG. 4A is a diagram illustrating an example of an external configuration of the mobile terminal device 103. In the present embodiment, as one example, a case where the mobile terminal device 103 is a common type of smartphone will be described. The mobile terminal device 103 is configured to include, for example, a display unit 402, an operation unit 403, and a power key 404. The display unit 402 is, for example, a display that includes a liquid crystal display (LCD) mechanism. The display unit 402 may display information using, for example, light emitting diodes (LEDs) and the like. In addition to or in place of the display unit 402, the mobile terminal device 103 may have a function for outputting information by voice. The operation unit 403 is configured to include physical keys (e.g., keys and buttons), a touch panel, and the like for detecting user operations. In this example, since display of information on the display unit 402 and acceptance of user operations by the operation unit 403 are performed using the same touch panel display, the display unit 402 and the operation unit 403 are realized by one device. In this case, for example, button icons and a software keyboard are displayed using the display function of the display unit 402, and the user's touch on those locations is detected by the operation reception function of the operation unit 403. A configuration may be taken so as to separate the display unit 402 and the operation unit 403 and separately provide hardware for display and hardware for operation acceptance. The power key 404 is a physical key for accepting a user operation for turning the power of the mobile terminal device 103 on or off.

The mobile terminal device 103 includes a WLAN unit 401, which provides a WLAN communication function, although it need not necessarily be externally visible. The WLAN unit 401 is configured to be capable of executing data (packet) communication in a WLAN system conforming to, for example, the IEEE 802.11 standard series (e.g., IEEE 802.11a/b/g/n/ac/ax), and is capable of communicating as an AP supporting Wi-Fi Agile Multiband™. However, the WLAN unit 401 is not limited thereto and may be capable of executing communication in a WLAN system conforming to another standard. In this example, it is assumed that the WLAN unit 401 is capable of performing communication in both the 2.4-GHz and 5-GHz frequency bands. Further, it is assumed that the WLAN unit 401 is capable of executing communication based on WFD, communication according to the soft AP mode, communication according to the infrastructure connection mode, and the like. Operations in these modes will be described later.

### (Configuration of Mobile Terminal Device)

FIG. 4B illustrates an example of a configuration of the mobile terminal device 103. The mobile terminal device 103 includes, in one example, a main board 411, which performs main control of the device itself, and the WLAN unit 429, which performs WLAN communication. The main board 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. Here, CPU is an acronym for central processing unit, ROM for read only memory, RAM for random access memory, and GPS for Global Positioning System. Further, the mobile terminal device 103 includes a display unit 420 and an operation unit 418. These functional units in the main board 411 are connected to each other through a system bus 427 managed by the CPU 412. Further, the main board 411 and the WLAN unit 429 are connected, for example, via a dedicated bus 426.

The CPU 412 is a system control unit including at least one processor and controls the entire mobile terminal device 103. The processes of the mobile terminal device 103 to be described below are realized, in one example, by the CPU 412 executing a program stored in the ROM 413. Dedicated hardware for each process may be provided. The ROM 413 stores control programs, an embedded operating system (OS) program, and the like to be executed by the CPU 412. In the present embodiment, the CPU 412 performs software control, such as scheduling and task switching, by executing the respective control programs stored in the ROM 413 under the management of the embedded OS, which is similarly stored in the ROM 413.

The RAM 414 is constituted by a static RAM (SRAM) or the like. The RAM 414 stores data such as program control variables and data such as setting values registered by the user and management data of the mobile terminal device 103. The RAM 414 may be used as a buffer for various kinds of work. The image memory 415 is constituted by a memory such as a dynamic RAM (DRAM). The image memory 415 temporarily stores image data received through the WLAN unit 429 and image data read from the data storage unit 423 for processing in the CPU 412. The non-volatile memory 422 is constituted by a memory, such as a flash memory, for example, and continues to store data even when the power of the mobile terminal device 103 is turned off. The memory configuration of the mobile terminal device 103 is not limited to the above configuration. For example, the image memory 415 and the RAM 414 may be shared, or the data storage unit 423 may be used, for example, to back up data. Further, although a DRAM has been given as an example of the image memory 415 in the present embodiment, another storage medium, such as a hard disk or a non-volatile memory, may be used.

The data conversion unit 416 analyzes various types of data and performs data conversion, such as color conversion and image conversion. The telephone unit 417 controls the telephone line and realizes communication by telephone by processing voice data inputted and outputted through the speaker unit 424. The GPS 419 receives radio waves transmitted from satellites and obtains position information of the mobile terminal device 103, such as the current latitude and longitude.

The camera unit 421 has a function for electronically recording and encoding an image inputted through a lens. Image data obtained by imaging by the camera unit 421 is stored in the data storage unit 423. The speaker unit 424 performs control for realizing a function for inputting or outputting a voice for the telephone function and a function for alarm notification and the like. The power supply unit 425 is, for example, a portable battery, and performs control for supplying power to the device. Power states include, for example, a battery exhausted state in which there is no remaining power in the battery, a power-off state in which the power key 404 has not been pressed, an active state in which the device is operating normally, and a power saving state in which the device is operating but saving power.

The display unit 420 is the display unit 402 described with reference to FIG. 4A and performs, for example, display of the status and the operation status of the mobile terminal device 103 and various input operations, based on the control of the CPU 412. The operation unit 418 is the operation unit 403 described with reference to FIG. 4A and, upon accepting a user operation, executes control such as generating an electric signal corresponding to the operation and outputting it to the CPU 412.

The mobile terminal device 103 performs wireless communication using the WLAN unit 429 and performs data communication with another device, such as the MFP 100. The WLAN unit 429 converts data into packets and transmits the packets to another device. The WLAN unit 429 reconstructs original data from packets from another, external device and outputs it to the CPU 412. The WLAN unit 429 is a unit for realizing communication conforming to the WLAN standards. The WLAN unit 429 can operate in parallel in at least two communication modes, including the infrastructure connection mode and the direct connection mode. The frequency bands to be used in these communication modes may be limited according to the functions and performance of the hardware.

### (Configuration of Access Point)

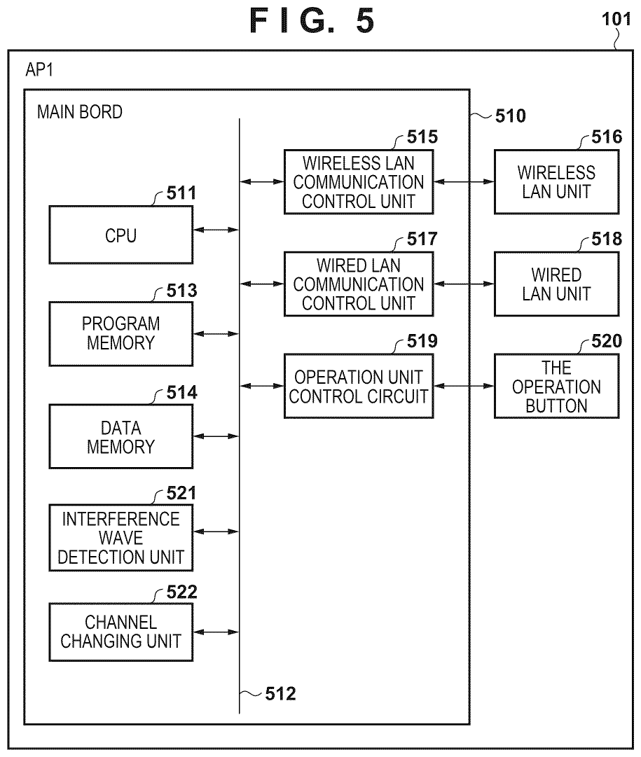

FIG. 5 is a block diagram illustrating a configuration of the AP 101 having a wireless LAN access point function. The AP 101 is configured to include a main board 510 which controls the AP 101, a wireless LAN unit 516, a wired LAN unit 518, and an operation button 520.

A CPU 511 in the form of a microprocessor arranged on the main board 510 operates according to a control program stored in a program memory 513 in the form of a ROM connected via an internal bus 512 and the contents of a data memory 514 in the form of a RAM. The CPU 511 performs wireless LAN communication with another communication terminal device by controlling the wireless LAN unit 516 through a wireless LAN communication control unit 515. The CPU 511 performs wired LAN communication with another communication terminal device by controlling the wired LAN unit 518 through a wired LAN communication control unit 517. The CPU 511 can accept an operation from the user through the operation button 520 by controlling an operation unit control circuit 519. The CPU 511 includes at least one processor.

Further, the AP 101 includes an interference wave detection unit 521 and a channel change unit 522. The interference wave detection unit 521 performs processing for detecting an interference wave when wireless communication is being executed in a frequency band in which Dynamic Frequency Selection (DFS) is performed. The channel change unit 522 performs processing for changing a channel to be used, for example, if an interference wave is detected or if an immediate change to a vacant channel is necessary, when wireless communication is being executed in a frequency band in which DFS is performed.

### (Direct Connection Mode)

Next, a direct connection mode in which devices wirelessly communicate in a direct manner with each other without going through an external access point in WLAN communication will be outlined. Communication according to the direct connection mode can be realized using a plurality of methods, and for example, a communication device can support a plurality of modes as direct connection modes and selectively use any of the plurality of modes to execute communication (direct communication) according to the direct connection mode. For example, there are the following two modes as the direct connection mode.
Soft AP Mode
Wi-Fi Direct (WFD) Mode

A communication device capable of executing direct communication may be configured to support at least one of these modes. Meanwhile, a communication device capable of executing direct communication need not support each of these modes and may be configured to support only one of them.

In a communication device (e.g., the mobile terminal device 103) having a communication function according to WFD, upon acceptance of a user operation through the operation unit thereof, an (in some cases, dedicated) application for realizing that communication function is called. The communication device may then display a user interface (UI) screen provided by that application to prompt a user operation and, based on the accepted user operation in response thereto, execute communication (WFD communication) according to the WFD mode.

### Soft AP Mode

In the soft AP mode, a communication device (e.g., the mobile terminal device 103) operates as a client, which requests various services. Another communication device (e.g., the MFP 100) operates as a soft AP capable of executing a WLAN AP function with software-based settings. The soft AP corresponds to a Wi-Fi master station, and a client corresponds to a Wi-Fi slave station. In the soft AP mode, a client searches for a device to be the soft AP according to a device search command. When the soft AP is discovered, remaining wireless connection processing (e.g., establishment of wireless connection) is performed between the client and the soft AP, and then IP connection processing (e.g., assigning of an IP address) is performed. Regarding commands and parameters to be transmitted and received when realizing wireless connection between the client and the soft AP, those specified in a Wi-Fi standard may be used, and the description thereof will be omitted here. The MFP 100, which operates in the soft AP mode, determines the frequency band and the frequency channel as the master station. Therefore, the MFP 100 can select which frequency band to use between 5 GHz and 2.4 GHz, for example, and which frequency channel to use in that frequency band.

### WFD Mode

A mode in which direct connection is executed by WFD is called the WFD mode. WFD is a standard established by Wi-Fi Alliance and is a standard included in the IEEE 802.11 series communication standard. In the WFD mode, after a search for a device to be a communication partner has been performed according to a device search command, group owner (GO) and client roles are determined, and then remaining wireless connection processing is performed. A group owner corresponds to a Wi-Fi master station (master device), and a client corresponds to a Wi-Fi slave station (slave device). This role determination corresponds to, for example, GO Negotiation. In the WFD mode in a state prior to role determination, the MFP 100 is in a state in which it is neither a master station nor a slave station. Specifically, between devices that perform communication, first, one device issues a device search command and searches for a device with which to connect in the WFD mode. When the other device to be a communication partner is discovered, information related to services and functions that each device can provide is confirmed between the two. This confirmation of device provision information is optional and not mandatory. This device provision information confirmation phase corresponds to, for example, Peer to Peer (P2P) Provision Discovery.

Next, by confirming each other's device provision information, it is determined which will be a client and which will a group owner as their roles. Next, when the client and the group owner are determined, they exchange parameters for communicating with each other via WFD. Remaining wireless connection processing and IP connection processing are performed between the client and the group owner based on the exchanged parameters. In the WFD mode, the MFP 100 may always operate as a GO without executing the above GO Negotiation in the MFP 100. That is, the MFP 100 may operate in WFD mode that is Autonomous GO mode. That is, a state in which the MFP 100 is operating in the WFD mode is, for example, a state in which connection via WFD is not established but the MFP 100 is operating as a GO or a state in which connection via WFD is established and the MFP 100 is operating as a GO.

In the present embodiment, when the MFP 100 establishes and maintains direct connection, the MFP 100 operates as a master station in a network to which it belongs. A master station is a device that constructs a wireless network and is a device that provides parameters used to connect to the wireless network to a slave station. The parameters used to connect to the wireless network are, for example, parameters related to the channel used by the master station. By receiving the parameters, a slave station connects to the wireless network constructed by the master station using the channels used by the master station. In the direct connection mode, the MFP 100 operates as a master station, and so, the MFP 100 can determine which frequency bands and channels to use for communication in the direct connection mode. In the present embodiment, assume that the MFP 100 can use channels corresponding to a 2.4-GHz frequency band and channels corresponding to a 5-GHz frequency band for communication according to the direct connection mode, for example.

### (Infrastructure Connection Mode)

In the communication according to the infrastructure connection mode, communication devices (e.g., the mobile terminal device 103 and the MFP 100) that communicate with each other are connected to an external AP (e.g., the AP 101) that controls a network, and communication between the communication devices is performed through the AP 101. In other words, communication between communication devices is executed via a network constructed by the external AP 101. The mobile terminal device 103 and the MFP 100 each search for the AP 101 according to a device search command. When the AP 101 is discovered, remaining wireless connection processing (e.g., establishment of wireless connection) is performed between each communication device and the AP 101, and then IP connection processing (e.g., assigning of an IP address) is performed. Regarding commands and parameters to be transmitted and received when realizing wireless connection between each communication device and the AP 101, those specified in a Wi-Fi standard may be used, and the description thereof will be omitted here.

In the present embodiment, when the MFP 100 operates in infrastructure connection, the AP 101 operates as a master station and the MFP 100 operates as a slave station. That is, in the present embodiment, infrastructure connection refers to connection between the MFP 100 operating as the slave station and a device (AP 101) operating as the master station. When the MFP 100 establishes an infrastructure connection and the mobile terminal device 103 establishes an infrastructure connection with the AP 101, communication via the AP 101 becomes possible between the MFP 100 and the mobile terminal device 103. The channels used for communication in infrastructure connection are determined by the AP 101, and so, the MFP 100 executes communication in infrastructure connection using the channels determined by the AP 101. In the present embodiment, assume that the MFP 100 can use channels corresponding to a 2.4-GHz frequency band and channels corresponding to a 5-GHz frequency band for communication in infrastructure connection. The MFP 100 can also use channels corresponding to a DFS band of the 5-GHz frequency band for communication in infrastructure connection. In order to communicate with the MFP 100 via the AP 101, the mobile terminal device 103 needs to recognize and identify that the MFP 100 belongs to a network that has been formed by the AP 101 and to which the mobile terminal device 103 belongs.

### (Connection Setting Processing for Connecting to External AP in Infrastructure Connection Mode)

The mobile terminal device 103 executes a setting (connection setting processing) for causing the MFP 100 to operate in at least one of the modes among infrastructure connection mode and direct connection mode, by using direct communication with the MFP 100. The connection setting processing in the present embodiment is temporarily executed by connecting devices to each other via direct communication, and that processing is also referred to as network setup. The connection setting processing may be executed in a state in which communication between the mobile terminal device 103 and the MFP 100 can be confirmed via wired communication or the like.

The MFP 100 operates in the connection setting mode (network setup mode) in order to execute the connection setting processing. Specifically, for example, the MFP 100 executes a wireless LAN access point function based on a vendor-specific Service Set Identifier (SSID), security, and password. Hereinafter, the connection setting processing is referred to as network setup, and the connection setting mode is referred to as network setup mode.

### (Regarding Network Setup Mode)

The network setup mode of the MFP 100 will be described. The MFP 100 can operate in network setup mode. A trigger for the MFP 100 to start operation in the network setup mode may be, specifically, for example, that the user presses a button for the network setup mode or that the MFP 100 is activated (powered on) for the first time after arrival. The button for the network setup mode may be a hardware (physical) button provided in the MFP 100 or a software button displayed by the MFP 100 on the operation display unit 201.

The MFP 100 enables Wi-Fi communication when it starts operating in the network setup mode. Specifically, for example, the MFP 100 enables an AP (setup AP) inside the MFP 100 dedicated to the network setup mode as Wi-Fi communication enabling processing. The SSID of the setup AP corresponds to the above vendor-specific SSID. With this, the MFP 100 enters a state in which it is possible to establish a direct connection via Wi-Fi with the mobile terminal device 103. Assume that connection information (SSID and password) for connecting with the setup AP is held in advance in an application (setup application) installed on the mobile terminal device 103. That is, the mobile terminal device 103 knows in advance the connection information for connecting with the setup AP. Assume that, therefore, unlike connection information of an AP that is enabled in the direct connection mode, the connection information for connecting to the setup AP cannot be changed as desired by the user. In the network setup mode, the MFP 100 may connect with the mobile terminal device 103 via Wi-Fi Direct (WFD) instead of traditional Wi-Fi. That is, the MFP 100 may operate as a group owner and receive connection information from the mobile terminal device 103 via WFD communication. Here, the connection information is, for example, connection information for the MFP 100 to connect to an external AP (e.g., the AP 101). Further, in the network setup mode, the MFP 100 may connect to the mobile terminal device 103 via Bluetooth. Here, Bluetooth includes Bluetooth Classic and Bluetooth Low Energy (BLE). That is, for example, the MFP 100 may operate as a slave device in BLE in the network setup mode and receive connection information from the mobile terminal device 103 via communication over BLE. Further, in the network setup mode, the MFP 100 may be capable of executing both network setup via Wi-Fi and network setup via BLE. That is, the MFP 100 may enable both Wi-Fi communication and BLE communication when it starts operating in the network setup mode. Specifically, the MFP 100 may execute both enabling of the setup AP and enabling of an advertising state, in which advertisement information is transmitted via BLE so as to allow BLE connection, when it starts operating in the network setup mode. Further, the MFP 100 may receive connection information from the mobile terminal device 103 via wired LAN or USB.

As described above, the MFP 100 operates in a network setup mode to execute network setup of the MFP 100 in accordance with predetermined conditions, which include a press of a button by the user and being at the time of initial installation. When operating in the network setup mode, the wireless LAN communication unit 207 operates as a setup AP, which is enabled only during operation in the network setup mode. The setup AP is an access point that is different from an access point that is enabled during the above soft AP mode. Further, assume that the SSID of the setup AP includes a predetermined character string that can be recognized by a setup application of the mobile terminal device 103.

Further, assume that the MFP 100 operating in the network setup mode uses a predetermined communication protocol (setup communication protocol) in communication with the mobile terminal device 103 connected with the setup AP. The setup communication protocol is, more specifically, Simple Network Management Protocol (SNMP), for example.

The MFP 100 stops operation in the network setup mode when a predetermined period of time elapses from the start of operation in the network setup mode and disables the setup AP. It also disables the setup AP when the connection information for connecting to an external AP and an instruction to change the wireless communication operation mode is received from the mobile terminal device 103 during the network setup mode. Hereinafter, an instruction transmitted from the mobile terminal device 103, which includes the above connection information and change instruction, is referred to as a “connection setting instruction”.

The mobile terminal device 103 executes a network setup when the CPU 412 reads out a predetermined computer program stored in the ROM 413 and executes the program. A predetermined program is an application program that includes, in addition to a function for executing network setup, a printing function for causing the MFP 100 to print image data, document data, and the like in the mobile terminal device 103, and is the above setup application. The setup application may include other functions in addition to a function for executing a network setup and the printing function. For example, the setup application may include a scan function for scanning a document set in the MFP 100, a function for executing other settings of the MFP 100, a function for confirming the state of the MFP 100, and the like. The setup application of the mobile terminal device 103 establishes a connection as a client to the SSID of the MFP 100 activated in network setup mode.

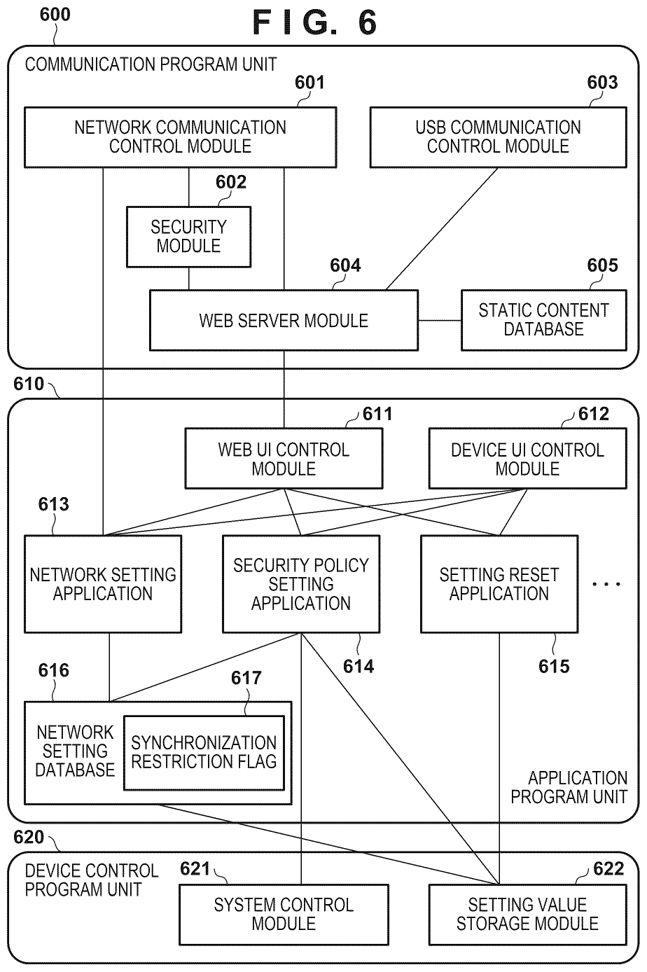

FIG. 6 is a block diagram conceptually illustrating a software configuration for realizing security policy setting and setting change of each network function in the software that operates in the MFP 100. The software elements and configuration illustrated in FIG. 6 are merely examples and do not limit the elements or configuration. The software group schematically illustrated in FIG. 6 is a control program stored in the ROM 213 and part of data stored in the RAM 214 that is associated therewith. The software group is configured to include a communication program unit 600 which mainly controls communication, an application program unit 610 which mainly controls application functions, and a device control program unit 620 which mainly controls low layers in the MFP 100.

The communication program unit 600 includes a network communication control module 601, a security module 602, a USB communication control module 603, a Web server module 604, and a static content database 605.

The network communication control module 601 is a module that controls the wireless LAN communication control unit 219 and is responsible for layers up to the transport layer of the communication protocol stack, and realizes TCP/IP communication of the MFP 100. Furthermore, the network communication control module 601 is also responsible for the network function control processing for obtaining the network setting state via a network setting application 613 in accordance with the power-on, power-off, and the like of the MFP 100 and activating or deactivating each network function accordingly.

The security module 602 is a module responsible for processing such as encryption and decryption of communication, as well as authentication and hashing associated therewith, and realizes Transport Layer Security (TLS)/Secure Sockets Layer (SSL) communication of the MFP 100. The USB communication control module 603 is a module that controls the USB communication control unit 218 and is responsible for operations for behaving as a USB device, and realizes USB communication of the MFP 100.

The Web server module 604 is a module responsible for operations for the MFP 100 to behave as a Web server, and realizes communication using Hypertext Transfer Protocol (HTTP) with the external mobile terminal device 103 on which a Web browser operates. Specifically, for example, it analyzes an HTTP request received from the external mobile terminal device 103, operates a Web UI control module 611 and the static content database 605 according to the analysis result, and formats the generated data as an HTTP response and transmits it. The Web server module 604 receives requests and transmits responses using TCP/IP communication, TLS/SSL communication, or USB communication.

The static content database 605 is a module that operates as a file system and reads JPEG data, HTML data, and the like stored in the ROM 213 or the RAM 214. The content database is not limited to static content, and may also be one in which content is generated dynamically.

The application program unit 610 includes the Web UI control module 611, a device UI control module 612, each application module from the network setting application 613 to a setting reset application 615, and a network setting database 616.

The Web UI control module 611 generates data for displaying a Web UI of the MFP 100 on the Web browser of the external mobile terminal device 103 in accordance with a request from the Web server module 604. The Web UI control module 611 can display the operation status or setting status of the MFP 100 on the Web UI by obtaining the operation status or setting status of the MFP 100 from each application module and returning the formatted data to the mobile terminal device 103. In addition, the Web UI displayed on the Web browser of the mobile terminal device 103 is configured to allow instructions for executing a change of settings of the MFP 100, password authentication, and the like. When the user operates the Web browser to instruct execution of a change of settings of the MFP 100, password authentication, and the like from the Web UI, the MFP 100 receives an HTTP request in which the instruction content is stored. The Web UI control module 611 accepts the instruction via the Web server module 604 and, causes the corresponding application module to perform processing such as setting changes or password authentication in accordance with the instruction content. When the processing is completed, the Web UI control module 611 stores the processing result, such as success or failure, in an HTTP response and transmits it to the mobile terminal device 103.

The device UI control module 612 realizes display of UI of the MFP 100 body by controlling the operation display control unit 221. The device UI control module 612 performs control so as to store menu hierarchy information and cause operation menus and the like to be displayed on the operation display unit 201 in accordance with the current menu hierarchy. In addition, the device UI control module 612 performs control so as to obtain the operation status and setting status of the MFP 100 from each application module, format them, and display them on the operation display unit 201. Furthermore, the device UI control module 612 accepts operation information such as setting changes or password authentication from the operation display control unit 221, and causes the corresponding application module to perform processing in accordance with the operation information. When the processing is completed, the device UI control module 612 performs control so as to cause the processing result, such as success or failure, to be displayed on the operation display unit 201.

The network setting application 613 receives instructions from the network communication control module 601, the Web UI control module 611, and the device UI control module 612, and obtains the network setting state and changes network settings.

A security policy setting application 614 receives instructions from the Web UI control module 611 and the device UI control module 612, and obtains the security policy setting state and changes security policy settings.

The setting reset application 615 receives instructions from the Web UI control module 611 and the device UI control module 612, and performs processing for resetting the setting values of the MFP 100.

The network setting database 616 includes a synchronization restriction flag 617, and upon a power ON of the MFP 100, holds in the RAM 214 a copy of each network setting stored in the NVRAM 215. The network setting database 616 receives instructions from the network setting application 613 and the security policy setting application 614, and performs processing for referencing and processing for changing each network setting. Further, in the processing for changing each network setting, the network setting database 616 switches whether to store the network setting in the NVRAM 215 via a setting value storage module 622, based on the state of the synchronization restriction flag 617 and the setting change content. Here, the synchronization restriction flag 617 has two states: on and off. That the synchronization restriction flag 617 is on indicates that synchronization between the copy of the network settings held in the RAM 214 by the network setting database 616 and the network settings held in the NVRAM 215 by the setting value storage module 622 is restricted. Further, that the synchronization restriction flag 617 is off indicates that synchronization between the copy of the network settings held in the RAM 214 by the network setting database 616 and the network settings held in the NVRAM 215 by the setting value storage module 622 is not restricted.

The device control program unit 620 includes a system control module 621 and the setting value storage module 622.

The system control module 621 is responsible for operations for controlling the entire software system, such as activation and deactivation of the MFP 100. For example, the system control module 621 accepts a reactivation request from the security policy setting application 614 and performs the reactivation processing of the MFP 100. The reactivation processing of the MFP 100 is processing in which, while the MFP 100 is in an active state, power-off processing is performed, directly followed by power-on processing. The system control module 621 also performs the power-on processing or power-off processing of the MFP 100 upon the user pressing the power button. In the power-on processing and the power-off processing, the system control module 621 operates so as to notify the main software modules of the MFP 100, such as the network communication control module 601, of a power-on command or a power-off command, and waits for the processing result (not illustrated).

The setting value storage module 622 operates so as to control, for example, the storage of setting values of the MFP 100. The setting value storage module 622 receives, from other modules such as each application module, instructions to store setting values, and writes the setting values to the NVRAM 215. Further, the setting value storage module 622 receives, from other modules such as each application module, instructions to reference setting values, and reads the setting values from the NVRAM 215.

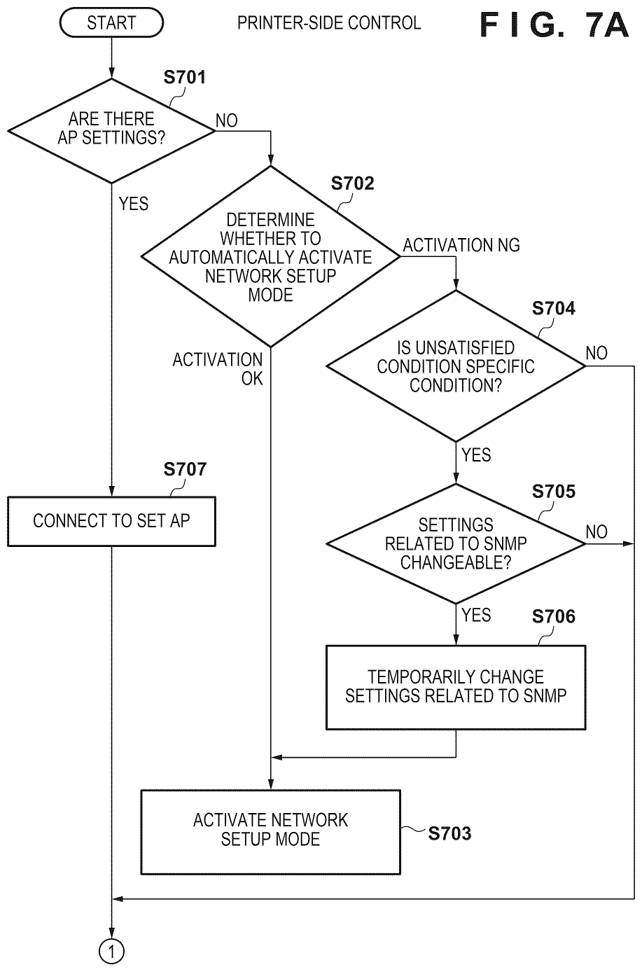

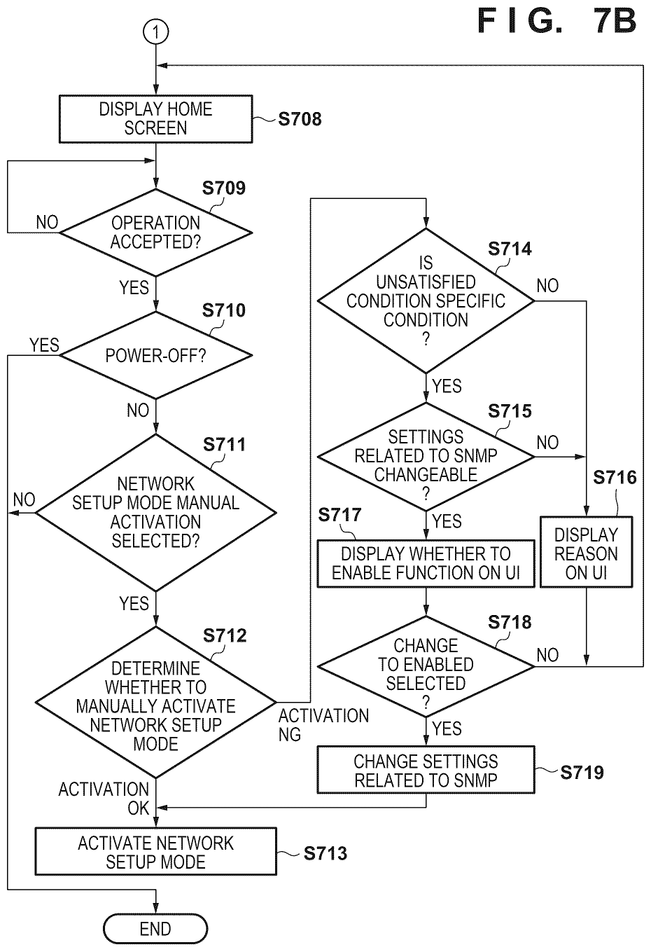

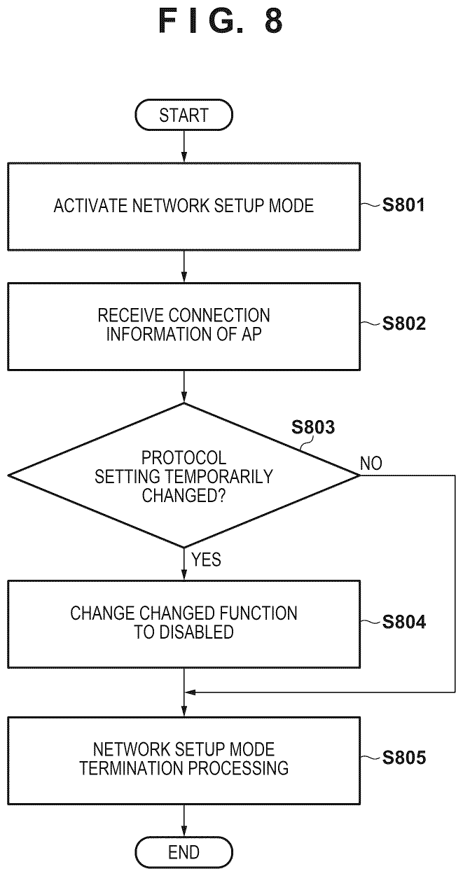

Next, processing in which the network setup is executed from the power-on of the MFP 100 will be described with reference to the flowcharts of FIGS. 7 and 8. The processing indicated in FIGS. 7A and 7B is realized, for example, by the CPU 211 of the MFP 100 reading a computer program stored in the ROM 213 and executing the program. The processing of FIGS. 7A and 7B is started based on the power of the MFP 100 being turned on.

In step S701, the CPU 211 determines whether settings of an external access point (external AP) are held in the MFP 100. Specifically, for example, wireless setting information stored in the MFP 100 is referenced, and it is determined whether information (e.g., SSID) for connecting to the external AP to which the MFP 100 had been connected is held. If it is determined that the settings of the external AP are held, the processing proceeds to step S707. In step S707, the CPU 211 connects to the external AP and then proceeds to step S708. Meanwhile, if it is determined that the settings of the external AP are not held, the processing proceeds to step S702.

In step S702, the CPU 211 determines whether conditions for automatically starting a network setup for connecting to an external AP are satisfied. The determination of step S702 is, in other words, a determination of whether conditions for activating in network setup mode are satisfied. Here, when one of the plurality of conditions for activating in network setup mode is not satisfied, it is determined that conditions for activating in network setup mode are not satisfied.

In step S702, specifically, for example, whether network settings such as LAN have yet to be performed is one of the above plurality of conditions. If network settings such as LAN have already been performed, it is determined that conditions for automatically starting a network setup for connecting to an external AP are not satisfied. Further, for example, whether WFD is set to be always active is one of the above plurality of conditions. If WFD is set to be always active, it is determined that conditions for automatically starting a network setup for connecting to an external AP are not satisfied. Further, for example, whether the state is that in which protocols and the like necessary to perform a network setup are operable is one of the above plurality of conditions. If the state is not that in which protocols and the like necessary to perform a network setup are operable, it is determined that the conditions for automatically starting a network setup for connecting to an external AP are not satisfied.

A state in which protocols and the like necessary to perform a network setup are operable will be described. For example, in a network setup, SNMP is used as a setup communication protocol in order for the MFP 100 to obtain connection information from the mobile terminal device 103. In the present embodiment, the MFP 100 can accept an operation for setting the use of SNMP to enabled or disabled from the user. In the present embodiment, the above operation can be accepted in both a setting screen for network settings and a setting screen for security policy settings. However, it is assumed that, when the above operation is accepted in the setting screen for security policy settings, the above operation cannot be accepted in the setting screen for network settings and settings related to SNMP cannot be changed. That is, it is assumed that, when the above operation has not been accepted in the setting screen for security policy settings, the above operation can be accepted in the setting screen for network settings. In addition, it is assumed that, while setting changes via the setting screen for network settings can be made by any user, setting changes via the setting screen for security policy settings are permitted only for administrator users (security administrators). The above operation may be accepted in a setting screen for changing the settings of the MFP 100 to be displayed by the mobile terminal device 103 to which the MFP 100 is connected. In such cases, an instruction corresponding to the operation in the setting screen is transmitted to the MFP 100, and upon accepting the instruction, the MFP 100 sets the use of SNMP to enabled or sets the use of SNMP to disabled based on the instruction. In a state in which the use of SNMP is set to enabled, the MFP 100 can use SNMP in the communication that the MFP 100 executes. Then, in a state in which the use of SNMP is set to disabled, the MFP 100 enters a state in which it cannot use SNMP in any communications executed by the MFP 100. In the following description, the state in which the use of SNMP is set to enabled or the state in which the use of SNMP is set to disabled may simply be referred to as the state in which SNMP is set to enabled or the state in which SNMP is set to disabled. Then, if SNMP is set to disabled, the MFP 100 cannot perform a network setup, which is processing that uses SNMP. In other words, this means that the network setup cannot be completed. That is, if SNMP is set to disabled through network settings or security settings, the state is not that in which protocols and the like necessary to perform a network setup are operable. Conversely, if SNMP is not set to disabled through network settings or security policy settings, such as when it is set to enabled, the state is that in which protocols and the like necessary to perform a network setup are operable. That is, in the present embodiment, it is assumed that a condition related to SNMP among the above plurality of conditions is that SNMP is set to enabled. Therefore, in step S702, it is determined whether SNMP is set to enabled, and if SNMP is set to enabled, it is deemed that the condition related to SNMP is satisfied.

Further, for example, when enabling Wi-Fi communication at the time of activating the MFP 100 in network setup mode, an HTTP Server function is used. Then, in the present embodiment, the MFP 100 can accept an operation for setting the use of the HTTP Server function to enabled or disabled from the user. In the present embodiment, the above operation can be accepted in both a setting screen for network settings and a setting screen for security policy settings. However, it is assumed that, when the above operation is accepted in the setting screen for security policy settings, the above operation cannot be accepted in the setting screen for network settings and settings related to the HTTP Server function cannot be changed. That is, it is assumed that, when the above operation has not been accepted in the setting screen for security policy settings, the above operation can be accepted in the setting screen for network settings. The above operation may be accepted in a setting screen for changing the settings of the MFP 100 to be displayed by the mobile terminal device 103 to which the MFP 100 is connected. In such cases, an instruction corresponding to the operation in the setting screen is transmitted to the MFP 100, and upon accepting the instruction, the MFP 100 sets the use of the HTTP Server function to enabled or sets the use of the HTTP Server function to disabled based on the instruction. In a state in which the use of the HTTP Server function is set to enabled, the MFP 100 can use the HTTP Server function in the communication that the MFP 100 executes. In a state in which the use of the HTTP Server function is set to disabled, the MFP 100 enters a state in which it cannot use the HTTP Server function in any communication executed by the MFP 100. In the following description, a state in which the use of the HTTP Server function is set to enabled and a state in which the use of the HTTP Server function is set to disabled may simply be referred to as a state in which the HTTP Server function is set to enabled or a state in which the HTTP Server function is set to disabled. Then, if the HTTP Server function is set to disabled, the MFP 100 cannot perform a network setup, which is processing that uses the HTTP Server function. In other words, this means that the network setup cannot be completed. In other words, if the HTTP Server function is set to disabled through network settings or security policy settings, the state is not that in which protocols and the like necessary to perform a network setup are operable. Conversely, if the HTTP Server function is not set to disabled through network settings or security policy settings, such as when it is set to enabled, the state is that in which protocols and the like necessary to perform a network setup are operable. That is, in the present embodiment, it is assumed that a condition related to the HTTP Server function among the above plurality of conditions is that the HTTP Server function is set to enabled. Therefore, in step S702, it is determined whether the HTTP Server function is set to enabled, and if the HTTP Server function is set to enabled, it is deemed that the condition related to the HTTP Server function is satisfied.

The plurality of conditions may include conditions other than the above condition related to SNMP and condition related to the HTTP Server function. For example, the MFP 100 may be capable of accepting operations for enabling or disabling the use of the wireless LAN communication function on the setting screen for network settings or the setting screen for security policy settings. In a state in which the use of the wireless LAN communication function is set to enabled, the MFP 100 can use the wireless LAN communication function. Further, in a state in which the use of the wireless LAN communication function is set to disabled, the MFP 100 enters a state in which it cannot use the wireless LAN communication function. Further, the plurality of conditions may include a condition that the wireless LAN communication function is set to enabled as a condition related to the wireless LAN communication function.

If it is determined in step S702 that all conditions are satisfied among the above plurality of conditions, the processing proceeds to step S703. In step S703, the CPU 211 activates the MFP 100 in network setup mode. Specifically, for example, it performs control so as to emit a beacon signal including a predetermined SSID. In step S703, the processing of FIG. 8, which will be described later, is executed. Meanwhile, if it is determined in step S702 that some conditions are not satisfied among all of the above plurality of conditions, the processing proceeds to step S704.

In step S704, the CPU 211 determines whether one condition that was not satisfied among the above plurality of conditions is a specific condition. In the present embodiment, a specific condition is that SNMP is set to disabled. Therefore, if SNMP is set to disabled, the CPU 211 determines YES in the determination, and proceeds to step S705, and if, despite SNMP not being set to disabled, it is determined in step S702 that conditions are not satisfied, the CPU 211 proceeds to step S708. A case where the processing proceeds to step S708 is, for example, a case where the HTTP Server function is set to disabled. In addition, if a plurality of conditions are not satisfied among the above plurality of conditions, the processing proceeds to step S708 even if the above specific condition is included among the unsatisfied conditions.

In step S705, the CPU 211 determines whether settings related to SNMP can be changed. Specifically, for example, if SNMP is set to disabled through an operation on the setting screen for security policy settings, users other than security administrators cannot change the settings related to SNMP. That is, it is not possible to change the settings related to SNMP without confirming authentication as a security administrator. Therefore, if SNMP is set to disabled through an operation on the setting screen for security policy settings, it is determined that the settings related to SNMP cannot be changed.

Meanwhile, if SNMP is set to disabled through an operation on the setting screen for network settings, any user can change the settings regardless of their user privilege. Therefore, if SNMP is set to disabled through an operation on the setting screen for network settings, it is determined that the settings related to SNMP can be changed.

If it is determined in step S705 that the settings related to SNMP can be changed, the processing proceeds to step S706. In step S706, the CPU 211 temporarily releases the function restrictions on the settings. Specifically, for example, if SNMP is set to disabled, it is temporarily changed to enabled. Here, “temporarily” means that the function restriction will be set again in later processing. That processing will be described later. In the present embodiment, specifically, the CPU 211 temporarily sets SNMP to enabled until SNMP is set to disabled based on receiving AP connection information transmitted from the mobile terminal device 103. After step S706, in step S703, the CPU 211 activates the MFP 100 in network setup mode. Meanwhile, if it is determined in step S705 that the settings related to SNMP cannot be changed, the processing proceeds to step S708. In step S706, the processing for changing the settings related to SNMP not temporarily but permanently until an operation on the setting screen for network settings or an operation on the setting screen for security policy settings is newly accepted may be executed.

Thus, in the present embodiment, if it is determined that the conditions for activating in network setup mode are not satisfied, control is performed to switch the processing according to whether the settings that caused the determination can be changed. For example, if the reason is that the state is not that in which protocols and the like necessary to perform a network setup are operable, and the settings can be temporarily changed, the settings are changed such that the protocols and the like become operable (function restrictions are released), and the MFP 100 is activated in network setup mode. Further, for example, if the reason is that the state is not that in which protocols and the like necessary to perform a network setup are operable, and the settings cannot be temporarily changed, the processing proceeds to step S708 without activating the MFP 100 in network setup mode.

A form in which the processing of step S705 is not executed may be taken.

Specifically, for example, the specific condition referenced in the determination of step S704 may be that SNMP is set to disabled through an operation on the setting screen for network settings. In this form, if SNMP is set to disabled through an operation on the setting screen for network settings, the CPU 211 proceeds to step S706 without executing step S705, and if, despite SNMP not being set to disabled through an operation on the setting screen for network settings, it is determined in step S702 that the conditions are not satisfied, the CPU 211 proceeds to step S708. A case where the processing proceeds to step S708 is, for example, a case where SNMP is set to disabled through an operation on the setting screen for security policy settings, a case where the HTTP Server function is set to disabled through an operation on the setting screen for network settings, or a case where the HTTP Server function is set to disabled through an operation on the setting screen for security policy settings. In addition, if a plurality of conditions are not satisfied among the above plurality of conditions, the processing proceeds to step S708 even if the above specific condition is included among the unsatisfied conditions.

In step S708, the CPU 211 displays a home screen on the operation display unit 201. The home screen is a screen that can accept user selection of each menu item such as print and scan which are executable on the MFP 100, and is, for example, the screen of FIG. 3A.

In step S709, the CPU 211 determines whether user selection of a menu item has been accepted on the home screen. If it is determined that user selection of a menu item has been accepted, the processing proceeds to step S710. The processing of step S709 is repeated until it is determined that user selection of a menu item has been accepted.

In step S710, the CPU 211 determines whether user selection of a power-off of the MFP 100 has been accepted. If it is determined that user selection of a power-off has been accepted, the processing of FIGS. 7A and 7B ends. Meanwhile, if it is determined that selection of a power-off has not been accepted, the processing proceeds to step S711.

In step S711, the CPU 211 determines whether a menu that manually activates the network setup mode has been selected. If it is determined that a menu that manually activates the network setup mode has been selected, the processing proceeds to step S712. Meanwhile, if it is determined that a menu item for manually activating the network setup mode has not been selected, the processing of FIGS. 7A and 7B ends, and then, the CPU 211 executes processing corresponding to the selected menu item.

In step S712, the CPU 211 determines whether conditions for starting a network setup for connecting to an external AP are satisfied. The determination of step S712 is, in other words, a determination of whether conditions for activating in network setup mode are satisfied. Here, when one of the plurality of conditions for activating in network setup mode is not satisfied, it is determined that conditions for activating in network setup mode are not satisfied. This determination is similar to step S702.

In step S712, specifically, for example, whether print processing or scan processing that uses a network is being executed is one of the above plurality of conditions. When print processing or scan processing that uses a network is being executed, it is determined that the conditions for starting a network setup for connecting to an external AP are not satisfied. Further, for example, whether the state is that in which protocols and the like necessary to perform a network setup are operable is one of the above plurality of conditions. If the state is not that in which protocols and the like necessary to perform a network setup are operable, it is determined that the conditions for starting a network setup for connecting to an external AP are not satisfied.

If it is determined in step S712 that the conditions are satisfied, in step S713 the CPU 211 activates the MFP 100 in network setup mode. Specifically, for example, the CPU 211 performs control so as to emit a beacon signal including a predetermined SSID. In step S713, the processing of FIG. 8, which will be described later, is executed. Meanwhile, if it is determined in step S712 that the conditions are not satisfied, the processing proceeds to step S714.

In step S714, the CPU 211 determines whether one condition that was not satisfied among the above plurality of conditions is a specific condition. This processing is similar to step S704. If it is determined to be YES in this determination, the processing proceeds to step S715, and if it is determined to be NO in this determination, the processing proceeds to step S716.

In step S715, the CPU 211 determines whether settings related to SNMP can be changed. This processing is similar to step S705. If it is determined to be YES in this determination, the processing proceeds to step S717, and if it is determined to be NO in this determination, the processing proceeds to step S716.

In step S716, the CPU 211 displays on the operation display unit 201 of the MFP 100 a message screen indicating the reason why the network setup mode cannot be activated. At this time, the CPU 211 displays a message based on conditions that were not satisfied among the above plurality of conditions. Specifically, for example, if a condition that is not satisfied among the above plurality of conditions is a condition related to SNMP, a message indicating that SNMP is set to disabled, or a message prompting the user to set SNMP to enabled is displayed. Further, for example, if a condition that is not satisfied among the above plurality of conditions is a condition related to the HTTP Server function, a message indicating that the use of the HTTP Server function is set to disabled, or a message prompting the user to set the use of the HTTP Server function to enabled is displayed. Further, the message displayed on the message screen may be based on whether the setting corresponding to the unsatisfied condition is a setting performed by an operation on the setting screen for network settings or a setting performed by an operation on the setting screen for security policy settings. Then, the processing from step S708 is repeated.

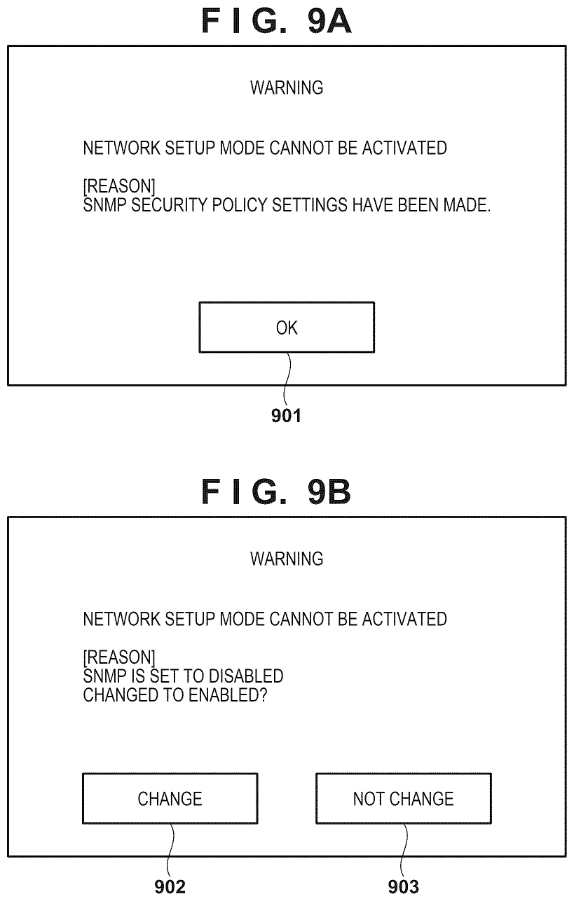

FIG. 9A is a diagram illustrating an example of a message screen displayed in step S716. FIG. 9A is a screen that is displayed based on SNMP being set to disabled through an operation on the setting screen for security policy settings. For example, as illustrated in FIG. 9A, a message indicating that SNMP is set to disabled in the security policy settings is displayed. Other reasons displayed on the message screen of FIG. 9A include, for example, that WFD is set to be always activated. Such a screen may be displayed, for example, when the processing proceeds from step S714 to step S716. In the message screen of FIG. 9A, an OK button 901 is displayed in a selectable manner, and when selection from the user is accepted, the processing proceeds to step S708.

In step S717, the CPU 211 displays a confirmation screen for confirming whether to change the settings related to SNMP on the operation display unit 201 of the MFP 100. This screen includes, for example, a message indicating the reason why the network setup mode cannot be activated. Then, the processing proceeds to step S718.

FIG. 9B is a diagram illustrating an example of a confirmation screen displayed in step S717. For example, as illustrated in FIG. 9B, a message indicating that SNMP is set to disabled in the network settings is displayed. Other reasons displayed on the screen of FIG. 9B include, for example, that the HTTP Server function is set to disabled in the network settings. A button 902 and a button 903 are displayed in a selectable manner in the confirmation screen of FIG. 9B. The button 902 is a button that can accept an instruction to change the settings, and the button 903 is a button that can accept an instruction to not change the settings. When selection of one of the buttons is accepted, the processing proceeds to step S718.

In step S718, the CPU 211 determines whether settings related to SNMP can be changed. Specifically, for example, if it is determined that the button 902 of FIG. 9B is selected, it is determined to change the settings related to SNMP, and if the button 903 of FIG. 9B is selected, it is determined to not change the settings related to SNMP. If it is determined to not change the settings related to SNMP, the processing from step S708 is repeated. Meanwhile, if it is determined to change the settings related to SNMP, the processing proceeds to step S719.

In step S719, the CPU 211 releases the function restrictions on the settings. Specifically, for example, if SNMP is set to disabled, it is changed to enabled. In this processing, similarly to the processing of step S706, it is assumed that the processing for changing the settings related to SNMP not temporarily but permanently until an operation on the setting screen for network settings or an operation on the setting screen for security policy settings is newly accepted is executed. Then, the processing proceeds to step S713, and the CPU 211 activates the MFP 100 in network setup mode.

In steps S703 and S713, the processing of FIG. 8 is executed, but before describing the processing of FIG. 8, the network setup processing performed between the mobile terminal device 103 and the MFP 100 will be described.

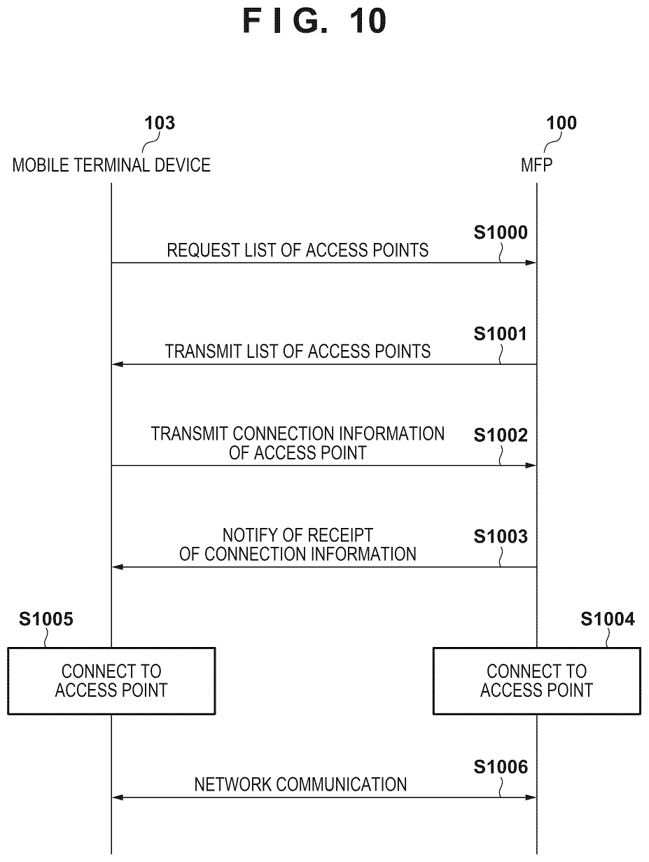

FIG. 10 is a sequence diagram illustrating network setup processing executed by the mobile terminal device 103 and the MFP 100. The processing of the mobile terminal device 103 illustrated in FIG. 10 is realized, for example, by the CPU 412 reading a program stored in the ROM 413 into the RAM 414 and executing the program. Further, the processing of the MFP 100 illustrated in FIG. 10 is realized, for example, by the CPU 211 reading a program stored in the ROM 213 into the RAM 214 and executing the program. In the communication between the MFP 100, which is operating in network setup mode, and the mobile terminal device 103 via Wi-Fi connection, a setup communication protocol, such as SNMP, is used.

In step S1000, the mobile terminal device 103 uses the setup application to request a list of access points from the MFP 100 via a Wi-Fi connection between the mobile terminal device 103 and the MFP 100, which is operating in network setup mode.

Next, in step S1001, the MFP 100 transmits the list of access points to the mobile terminal device 103 via a Wi-Fi connection between the MFP 100, which is operating in network setup mode, and the mobile terminal device 103. Here, the list that is transmitted is a list indicating one or more access points that the MFP 100 can connect to, discovered by the MFP 100 executing an AP search.

Next, in step S1002, the mobile terminal device 103 transmits the connection information of one of the access points included in the received list to the MFP 100 via a Wi-Fi connection between the MFP 100, which is operating in network setup mode, and the mobile terminal device 103. This processing is realized by the setup application controlling the mobile terminal device 103 to transmit the connection information of one of the access points included in the received list. Specifically, in this processing, if the received list includes a connected AP, the mobile terminal device 103 transmits the connection information of the connected AP. In the present embodiment, since the list includes only access points that the MFP 100 can connect to, the case where the received list includes a connected AP means, in other words, that the MFP 100 is capable of connecting to the connected AP. Further, if the received list does not include a connected AP, the mobile terminal device 103 displays the received list and accepts, from the user, selection of one of the access points from the list. Then, the mobile terminal device 103 transmits the connection information of the selected access point. In the present embodiment, since the list includes only access points that the MFP 100 can connect to, the case where the received list does not include a connected AP means, in other words, that the MFP 100 is not capable of connecting to the connected AP. In addition, access points that can be connected to using an encryption method not supported by the MFP 100 are not included in the list, since the MFP 100 cannot connect to them. In addition, access points that can be connected to using a frequency band not supported by the MFP 100 are not included in the list, since the MFP 100 cannot connect to them. Before the connection information is transmitted, the mobile terminal device 103 accepts input of the password for connecting to the access point from the user on a screen displayed by the setup application. Then, the accepted password is included in the connection information, and the connection information is transmitted.

In step S1003, the MFP 100 notifies the mobile terminal device 103 via the Wi-Fi connection between the MFP 100, which is operating in network setup mode, and the mobile terminal device 103, that the connection information has been received.

In step S1004, the MFP 100 ends the network setup mode and transitions to the infrastructure mode. Then, the MFP 100 attempts to connect to the access point corresponding to the connection information obtained in step S1002, using the connection information. If the connection is successful, thereafter, the MFP 100 can communicate via the network formed by the connected access point.

In step S1005, the mobile terminal device 103 uses the setup application to reconnect to the access point to which the mobile terminal device 103 has been connected when an operation related to network setup was performed, using the stored connection information. The present invention is not limited to this form. For example, in cases such as those where the mobile terminal device 103 has transmitted to the MFP 100 the connection information of another access point different from the access point to which the mobile terminal device 103 had been connected via Wi-Fi when an operation related to network setup was performed, the mobile terminal device 103 may connect to that other access point.

In step S1006, the mobile terminal device 103 uses the setup application to search for the MFP 100 on the network to which it belongs. Then, when the MFP 100 is discovered, the mobile terminal device 103 requests capability information from the MFP 100, and the MFP 100 transmits the capability information to the mobile terminal device 103. With this, information of the MFP 100 is registered in the setup application, and thereafter, it is possible to execute communication with the MFP 100 through the setup application. Specifically, for example, the setup application allows transmission of a print job to the MFP 100. At this time, if the mobile terminal device 103 belongs to the network formed by the access point to which the MFP 100 is connected by network setup, it is possible to execute communication with the MFP 100 via that access point. If communication between the mobile terminal device 103 and the MFP 100 cannot be executed, such as when the access point to which the MFP 100 is connected is not the access point to which the mobile terminal device 103 is connected, the request for and acquisition of capability information is omitted. The communication in step S1006 is executed using, for example, a communication protocol different from the setup communication protocol (specifically, for example, CHMP). Then, the processing in the sequence diagram of FIG. 10 ends.

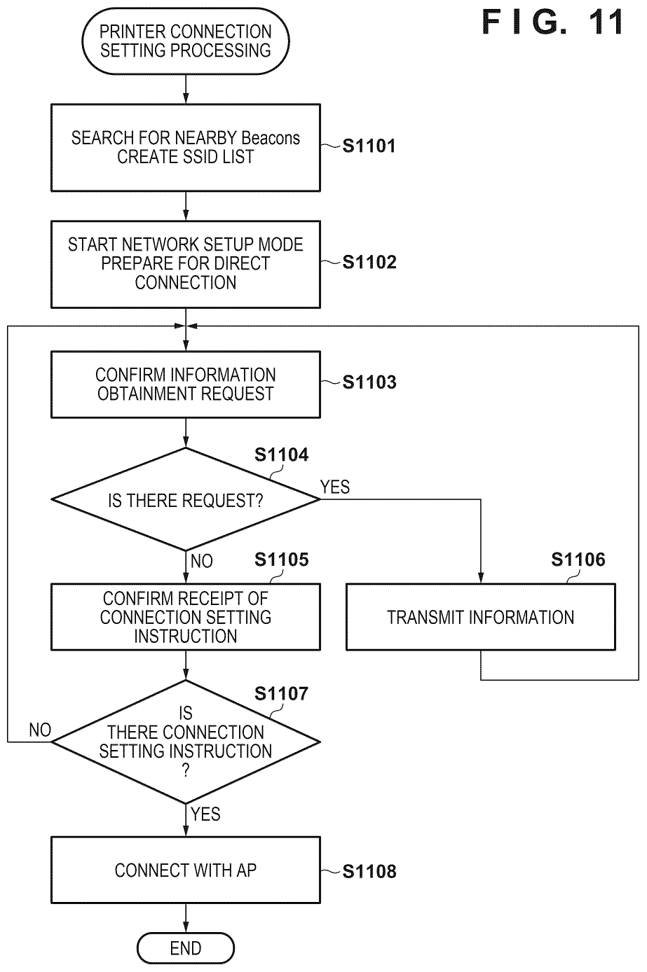

FIG. 11 is a flowchart for explaining a network setup executed in the MFP 100. The processing of FIG. 11 is realized, for example, by the CPU 211 of the MFP 100 reading a program stored in the ROM 213 into the RAM 214 and executing the program. The processing of FIG. 11 is started in the processing of steps S703 and S713 of FIGS. 7A and 7B.

In step S1101, the CPU 211 uses the wireless LAN communication unit 207 to search for nearby beacons and create an SSID list. Here, the SSID list is a list indicating one or more access points that the MFP 100 can connect to, discovered by the MFP 100 executing an AP search.

In step S1102, the CPU 211 starts the network setup mode and prepares for direct connection via wireless connection with the mobile terminal device 103. Preparation for direct connection is processing in which the wireless LAN communication unit 207 is operated in network setup mode, a beacon is transmitted, and a connection with the mobile terminal device 103 is awaited. At this time, the MFP 100 operates in network setup mode.

When the mobile terminal device 103 connects to the wireless LAN communication unit 207 of the MFP 100 operating in network setup mode and a direct connection via wireless connection is established, the processing proceeds to step S1103.

In step S1103, the CPU 211 confirms an information obtainment request from the mobile terminal device 103. In step S1104, the CPU 211 determines whether there is a request for an SSID list from the mobile terminal device 103 to the MFP 100, as an information obtainment request from the mobile terminal device 103. Here, the request for an SSID list refers to a request for an SSID list from the mobile terminal device 103 to the MFP 100, and corresponds to the request for a list of access points in step S1000 of FIG. 10. If it is determined that there is a request for an SSID list, the processing proceeds to step S1106, and if it is determined that there is no request for an SSID list, the processing proceeds to step S1105. In step S1106, the CPU 211 transmits the SSID list to the mobile terminal device 103, which is the source of the request. Then, the processing from step S1103 is repeated.

In step S1105, the CPU 211 confirms an instruction from the mobile terminal device 103. In step S1107, the CPU 211 determines whether there is a connection setting instruction from the mobile terminal device 103 to the MFP 100, as an instruction from the mobile terminal device 103. Here, the connection setting instruction is an instruction from the mobile terminal device 103 to the MFP 100 as part of transmission of information for connecting to the AP 101, and corresponds to the transmission of access point connection information in step S1002 of FIG. 10. If it is determined that there is a connection setting instruction, the processing proceeds to step S1108, and if it is determined that there is no connection setting instruction, the processing from step S1103 is repeated.

In step S1108, the CPU 211 ends the network setup mode and transitions to the infrastructure connection mode. That is, the CPU 211 connects the wireless LAN communication unit 207 to the SSID of the AP 101 as instructed by the mobile terminal device 103, and establishes a wireless connection in infrastructure connection mode. Thereafter, the MFP 100 can execute communication via the network formed by the connected AP 101. After step S1108, the processing of FIG. 11 ends.

As described in FIGS. 10 and 11, in the network setup processing, the MFP 100 ends the network setup mode. In the present embodiment, when ending the network setup mode of the MFP 100, by executing the processing of FIG. 8, processing for returning the content of the setting items temporarily changed in step S706 to the content of the settings before the change is executed. This makes it possible to maintain the state of settings prior to the execution of the network setup.

FIG. 8 is a flowchart for explaining processing executed after the execution of a network setup in step S703 or S713. The processing indicated in FIG. 8 is realized, for example, by the CPU 211 of the MFP 100 reading a computer program stored in the ROM 213 and executing the program.

In step S801, the CPU 211 activates the MFP 100 in network setup mode. This processing corresponds to the processing of step S1102 of FIG. 11.

In step S802, the connection information of the AP transmitted from the mobile terminal device 103 is received. The processing of step S802 corresponds to the case where it is determined to be Yes in step S1002 of FIG. 10 or step S1107 of FIG. 11.

In step S803, the CPU 211 determines whether the function restrictions have been temporarily released in step S706 prior to activating the network setup mode. Here, even if the function restrictions on the settings have been released in step S719, that release is not considered a temporary release. This is because, in the case where the processing proceeds to step S719, the network setup mode has been manually activated, and furthermore, user confirmation is performed by displaying in step S717 a selection for whether to change the settings. That is, in the present embodiment, the release of function restrictions based on the intention of the user is not considered a temporary release of function restrictions in step S803.

If it is determined in step S803 that function restrictions have been temporarily released in step S706, in step S804 the CPU 211 sets function restrictions again and proceeds to step S805. Meanwhile, if it is determined that function restrictions have not been temporarily released in step S803, the processing proceeds from step S803 to step S805.

In step S805, the CPU 211 ends the network setup mode. The processing of step S805 corresponds to step S1004 of FIG. 10 or step S1108 of FIG. 11.

As described above, according to the present embodiment, when the MFP 100 is activated in network setup mode, if protocols and functions necessary for network setup are set to disabled, it is determined whether it is possible to temporarily change them to enabled based on whether the settings are those according to the security policy setting. Then, if it is determined that it is possible to temporarily change them to enabled, they are changed to enabled, and the network setup is started. Furthermore, by returning the settings to disabled when ending the network setup mode, the network settings before the change are maintained. Further, according to the present embodiment, when the MFP 100 cannot be activated in network setup mode, the user can be notified of the reason why activation is not possible.

The present disclosure is applicable to a personal computer, a PDA, a tablet terminal, a mobile telephone terminal (e.g., a smartphone), a music player, a game console, an electronic book reader, a smartwatch, and various measuring devices (sensor devices such as a thermometer and a hygrometer). Further, the present disclosure is applicable to a digital camera (including a still camera, a video camera, a network camera, and a security camera), a printer, a scanner, and a drone. Further, the present disclosure is applicable to a video output device, an audio output device (e.g., a smart speaker), a media streaming player, a wireless LAN station (adapter) that can be connected to a USB terminal or a LAN cable terminal, and the like. The video output device includes a device that realizes streaming reproduction in a display device and mirroring display (display in which the content displayed on an electronic device is also displayed on a display device) by, for example, obtaining (downloading) a moving image on the Internet identified by a URL instructed by the electronic device and outputting it to a display device connected through a video output terminal, such as HDMI®. Further, the video output device includes a media player (e.g., a TV, a hard disk recorder, a Blu-ray recorder, a DVD recorder), a head-mounted display, a projector, a TV, a display device (monitor), a signage device, and the like. Further, the present disclosure is applicable to a device capable of Wi-Fi connection, which is a so-called smart home appliance, such as an air conditioner, a refrigerator, a washing machine, a vacuum cleaner, an oven, a microwave oven, a lighting fixture, a heating appliance, and a cooling appliance.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-187682, filed Oct. 24, 2024 which is hereby incorporated by reference herein in its entirety.

What is claimed is:

1. A communication device comprising:
at least one memory and at least one processor which function as:
a connection setting unit configured to execute connection setting processing for connecting the communication device to an external access point;
a setting unit configured to perform setting so as to restrict a function of the communication device; and
a first control unit configured to perform control so as to, in a case where a function necessary for executing the connection setting processing is restricted by the setting unit, not start the connection setting processing and display information indicating that the function is restricted.

2. The communication device according to claim 1, wherein
the setting unit is further configured to function as:
a first setting unit configured to be capable of setting a restriction on a function of the communication device by accepting an operation of a user having a specific privilege; and
a second setting unit configured to be capable of setting a restriction on a function of the communication device regardless of a privilege of a user.

3. The communication device according to claim 2, wherein
in a case where a restriction on a function of the communication device is set by the first setting unit, the first control unit performs control so as to display a first screen including a message indicating that the function is restricted.

4. The communication device according to claim 3, wherein
the first screen is a screen in which a selection as to whether to release the restriction on the function of the communication device set by the first setting unit cannot be accepted.

5. The communication device according to claim 3, wherein
in a case where a restriction on a function of the communication device is set by the second setting unit, the first control unit performs control so as to display a second screen including a message indicating that the function is restricted.

6. The communication device according to claim 5, wherein
the second screen is a screen in which a selection as to whether to release the restriction on the function of the communication device set by the second setting unit can be accepted.

7. The communication device according to claim 6, wherein
in a case where a selection to release the restriction on the function of the communication device is accepted in the second screen, the first control unit performs control so as to release the restriction on the function of the communication device set by the second setting unit and cause the connection setting unit to start the connection setting processing.

8. The communication device according to claim 6,
wherein the at least one processor further function as:
a first determination unit configured to, in a case where an instruction to execute the connection setting processing is accepted through a user operation, determine whether the connection setting processing can be executed, and
wherein the control by the first control unit is executed in a case where the first determination unit determines that the connection setting processing cannot be executed.

9. The communication device according to claim 8, wherein
in a case where the first determination unit determines that the connection setting processing can be executed, the first control unit performs control so as to cause the connection setting unit to start the connection setting processing.

10. The communication device according to claim 8, wherein
in a case where, after the first screen is displayed or after a selection to not release the restriction on the function of the communication device is accepted in the second screen, an instruction to execute the connection setting processing is accepted through the user operation, the determination by the first determination unit is repeatedly executed.

11. The communication device according to claim 8,
wherein the at least one processor further function as:
a second determination unit configured to, in a case where the communication device is activated, determine whether the connection setting processing can be executed; and
a second control unit configured to perform control so as to, in a case where the second determination unit determines that the connection setting processing cannot be executed, and the function necessary for executing the connection setting processing is restricted by the first setting unit, not start the connection setting processing.

12. The communication device according to claim 11, wherein
the control by the first control unit is executed after a home screen of the communication device is displayed, and the control by the second control unit is executed before the home screen is displayed.

13. The communication device according to claim 12, wherein
in a case where the second determination unit determines that the connection setting processing can be executed, the second control unit performs control so as to cause the connection setting unit to start the connection setting processing.

14. The communication device according to claim 12, wherein
in a case where the second determination unit determines that the connection setting processing cannot be executed, and the second setting unit has set a restriction on a function of the communication device, the second control unit performs control so as to release the restriction on the function of the communication device set by the second setting unit and cause the connection setting unit to start the connection setting processing.

15. The communication device according to claim 14, wherein
the connection setting processing includes processing for ending operation of the communication device in a predetermined mode, and
the second control unit performs control so as to, in a case where the restriction on the function of the communication device set by the second setting unit has been released, restrict the function again in the processing.

16. The communication device according to claim 12, wherein
in a case where the second determination unit determines that the connection setting processing cannot be executed, and the first setting unit has set a restriction on a function of the communication device, the second control unit performs control so as to not start the connection setting processing and display the home screen.

17. The communication device according to claim 11, wherein
the connection setting processing is started by the communication device operating in a predetermined mode, and
the first control unit and the second control unit perform control so as to not start the connection setting processing by not setting the communication device to the predetermined mode.

18. The communication device according to claim 2, wherein
the setting by the first setting unit is a security policy setting, and the setting by the second setting unit is a network setting.

19. The communication device according to claim 1, wherein
the communication device is a printing device.

20. A control method executed in a communication device, the method comprising:
executing connection setting processing for connecting the communication device to an external access point;
performing setting so as to restrict a function of the communication device; and
performing control so as to, in a case where a function necessary for executing the connection setting processing is restricted by the setting unit, not start the connection setting processing and display information indicating that the function is restricted.

21. A non-transitory computer-readable storage medium that stores one or more programs including instructions, which when executed by one or more processors of a communication apparatus, cause the communication apparatus to execute a method comprising:
executing connection setting processing for connecting the communication device to an external access point;
performing setting so as to restrict a function of the communication device; and
performing control so as to, in a case where a function necessary for executing the connection setting processing is restricted by the setting unit, not start the connection setting processing and display information indicating that the function is restricted.
